(19) United States
(12) Patent Application Publication
(10) Pub. No.: US 2003/0004697 A1
(43) Pub. Date: Jan. 2, 2003

(54) Method of designing, modelling or fabricating a communications baseband stack

(76) Inventor: Gavin Robert Ferris, London (GB)

Correspondence Address: Richard C Woodbridge, Woodbridge & Associates, P O Box 592, Princeton, NJ, 08542-0592, US

(21) Appl. No.: 10/182,042

(22) PCT Filed: Jan. 24, 2001
(86) PCT No.: PCT/GB01/00278

(30) Foreign Application Priority Data
Jan. 24, 2000 (GB) 0001585.9

(51) Int. Cl. G06F 9/45

(52) U.S. Cl. 703/13

(57) ABSTRACT

A method of designing, modelling or fabricating a communications baseband stack, comprising the steps of: (a) creating a description of one or more of the following parameters of the baseband stack: (i) resource requirements; (ii) capabilities; (iii) behavior; and (b) using that description as an input to software comprising a virtual machine layer optimised for a communications DSP in order to generate an emulation of the baseband stack to be designed, modelled or fabricated.

### FIELD OF THE INVENTION

This invention relates to software for designing, modelling or fabricating a communications baseband stack. Communications baseband stacks are used for digital signal processing in communications equipment.

### DESCRIPTION OF THE PRIOR ART

Technology Background: Digital Signal Processing, DSPs and Baseband Stacks.

Digital signal processing is a process of manipulating digital representations of analogue and/or digital quantities in order to transmit or recover intelligent information which has been propagated over a channel. Digital signal processors perform digital signal processing by applying high speed, high numerical accuracy computations and are generally formed as integrated circuits optimised for high speed, real-time data manipulation. Digital signal processors are used in many data acquisition, processing and control environments, such as audio, communications, and video. Digital signal processors can be implemented in other ways, in addition to integrated circuits; for example, they can be implemented by micro-processors and programmed computers. The term ‘DSP’ used in this specification covers any device or system, whether in software or hardware, or a combination of the two, capable of performing digital signal processing. The term ‘DSP’ therefore covers one or more digital signal processor chips; it also covers the following: one or more digital signal processor chips working together with one or more external co-processors, such as a FPGA (field programmable gate array) or an ASIC programmed to perform digital signal processing; as well as any Turing equivalent to any of the above.

In the communications sector, a DSP will be a critical element for a baseband stack as the baseband stack runs on the DSP; the stack plus DSP together perform digital signal processing. The term ‘baseband stack’ used in this specification means a set of processing steps (or the structures which perform the steps) including one or more of the following: source coding, channel coding, modulation, or their inverses, namely source decoding, channel decoding and demodulation. In addition, the term ‘baseband stack’ should be construed as including structures capable of processing digital signals without any form of down conversion; a software radio would include such a baseband stack. As will be appreciated by the skilled implementer, source coding is used to compress a signal (i.e. the source signal) to reduce the bitrate. Channel coding adds structured redundancy to improve the ability of a decoder to extract information from the received signal, which may be corrupted. Modulation alters an analogue waveform in dependence on the information to be propagated.

Baseband stacks are found in mobile telephones (e.g. a GSM stack or a UMTS stack) and digital radio receivers (e.g. a DAB stack), as well as other one and two-way digital communications devices. The term ‘communications’ used in this specification covers all forms of one or two way, one to one and one to many communications and broadcasting. The terms ‘designing’ and ‘modelling’ typically includes the processes of one or more of emulation, resource calculation, diagnostic analysis, hardware sizing, debugging and performance estimating.

The Increasing Complexity of Communications Systems Places Intense Pressure on Baseband Stack Development

The complexity of communications systems is increasing on an almost daily basis. There are a number of drivers for this: traffic on the Internet is increasing at 1000% pa. Much of this (largely bursty) data is moving to wireless carriers, but there is less and less spectrum available on which to host such services. These facts have led to the use of ever more complex signal processing algorithms, in order to squeeze as much data as possible into the smallest possible bandwidth. In fact, the complexity of these algorithms has been increasing faster than Moore's law (i.e that computing power doubles every 18 months), with the result that conventional DSPs are becoming insufficient. For complex terminals, therefore, an ASIC must be produced to manage the vast parallel processing load involved. However, this is where the problems really begin. For not only are the algorithms used more complex on the signal processing front; the use of bursty, variable-QoS, often ephemeral transport channels, mandated by the move from primarily voice traffic to primarily Internet-related traffic, needs ever more sophisticated control plane software, even at Layer 1 (which requires hard real-time code). Conventional DSP toolsets do not provide an appropriate mechanism to address this problem, and as a result many current designs are not scalable to deal with ‘real world’ data applications.

However, the high MIPs requirements of modern communication systems represent only part of the story. The other problem arises when a multiplicity of standards (e.g., GSM, IS-136, UMTS, IS-95 etc.) need to be deployed within a single SoC (System on a Chip). SoC devices supporting multiple standards will be increasingly attractive to device vendors seeking to tap efficiently different markets in different countries; also, it is expected that the next generation UMTS phones will have not only GSM (or current generation) capabilities but also added features, such as DAB (Digital Radio Broadcasting) receivers, hence requiring baseband stacks for UMTS, GSM and DAB. The complexity of communications protocols is now such that no single company can hope to provide solutions for all of them. But there is an acute problem building an SoC which integrates IP from multiple vendors (e.g. the IP in the three different baseband stacks listed above) together into a single coherent package in increasingly short timescales: no commercial system currently exists in the market to enable multiple vendors' IP to be interworked. Layer 2 and layer 3 software (generally, soft real-time code) is more straightforward, since it may simply be run as one process of many as software on a DSP or other generalised processor. But layer 1 IP (hard real time, often parallel) algorithms, present a much more difficult problem, since the necessary hardware acceleration often dominates the architecture of the whole layer, providing non-portable, fragile, solution-specific IP.

Overview of Deficiencies in Current Models of Baseband Stack Development

In the past, baseband stacks have been relatively simple, the amount of required high-MIPs functionality has been relatively small and only modest amounts of multi-standard, multi-vendor integration have been performed. But as noted above, none of these now apply: (a) the bandwidth pressure means that ever more complex algorithms (e.g., turbo decoding, MUD, RAKE, etc.) are employed, necessitating the use of hardware; (b) the increase in packet data traffic is also driving up the complexity of layer 1 control planes as more birth-death events and reconfigurations must be dealt with in hard real time; and (c) time to market, standard diversification and differentiation pressures are leading vendors to integrate more and more increasingly complex functionality (3G, Bluetooth, 802.11, etc.) into a single device in record time—necessitating the licensing of layer 1 IP to produce an SoC (system on chip) for a particular target application.

Currently, there is no adequate solution for this problem; the VHDL toolset providers (such as Cadence and Synopsis) are approaching it from the ‘bottom up’—their tools are effective for producing individual high-MIPs units of functionality (e.g., a Viterbi accelerator) but do not provide tools or integration for the layer 1 framework or control code. DSP vendors (e.g., TI, Analog Devices) do provide software development tools, but their real time models are static (and so do not cope well with packet data burstiness) and their DSPs are limited by Moore's law, which acts as a brake to their usefulness. Furthermore, communication stack software is best modelled as a state machine, for which C or C++ (the languages usually supported by the DSP vendors) is a poor substrate.

Detailed Analysis of Deficiencies in Current Models of Baseband Stack Development

Conventionally, baseband stack development for digital communications is fragmented and highly specialised. For example, the initial development of the signal processing algorithms that are the heart of a baseband stack is generally performed on a mathematical modelling environment (such as Matlab), with fitting to a particular memory and MIPs (Million Instructions per Second) budget for the final target DSP being done by skilled estimation using a conventional spreadsheet. Once this modelling process has been performed satisfactorily, code modules and infrastructure software for the stack will be written, adapting existing libraries where possible (and possibly an RTOS (Real-Time Operating System)). Then, a ‘real time’ prototype hardware system will be built (sometimes called a ‘rack’) in which any required hardware acceleration will be prototyped on PLDs (Programmable Logic Device) where possible. This will be tested off air, and necessary changes made to the code. Once satisfactory, the stack will be ‘locked off’ and the final ASIC (Application Specific Integrated Circuit) (incorporating the hardware acceleration modules as on-chip peripherals) will be produced. The resultant baseband DSP or DSP components is then tested and then shipped.

There are a number of problems with this ‘traditional’ approach. The more important of these are that:

The resulting stacks tend to have a lot of architecture specificity in their construction, making the process of ‘porting’ to another hardware platform (e.g. a DSP from another manufacturer) time consuming.

The stacks also tend to be hard to modify and ‘fragile’, making it difficult both to implement in-house changes (e.g., to rectify bugs or accommodate new features introduced into the standard) and to licence the stacks effectively to others who may wish to change them slightly.

Integration with the MMI (Man Machine Interface) tends to be poor, generally meaning that a separate microcontroller is used for this function within the target device. This increases chip count and cost.

The process is quite slow, with about 1 year minimum elapsed time to produce a baseband processor for a significantly complex system, such as DAB (Digital Audio Broadcasting).

The process puts a lot of stress on technical authorities—so called ‘gurus’—to govern the overall best way to allocate buffers, manage downconversion, insert digital filters, generate good channel models and so on. This is generally a disadvantage since it adds a critical path and key personnel dependency to the project of stack production and lengthens timelines. The resulting product is quite likely not to include all the appropriate current technology because no individual is completely expert across all of the prevailing best practice, nor will the gurus or their team necessarily have time to incorporate all of the possible innovations in a given stack project even if they did know them.

The reliance on manual computation of MIPs and memory requirements, and the bespoke nature of the DSP modules and infrastructure code for the stack, means that there is an increased probability of error in the product.

An associated point is that generally real-time prototyping of the stack is not possible until the ‘rack’ is built; a lack of high-visibility debuggers available even at that point means that final stack and resource ‘lock off’ is delayed unnecessarily, pushing out the hardware production time scale. High visibility debuggers would, if available, be very useful since they provide, when developing in a high level language like C++, the ability in the development tool to place break points in the code, halt the processing at that point and then examine the contents of memory, single step instructions to see their effects, etc. Triggers can then also be placed in the code that will stop execution and start up the debugger when particular conditions arise. These are very powerful tools when developing application software. ‘Lock-off’ refers to the fact that when one phase of the project is complete, development can move onto the next. In a hardware development you cannot iterate as easily as in software as each iteration requires expensive or time consuming fabrication.

Because it is likely that low-level modules or hardware acceleration ‘controllers’ will have to be developed for the stack being produced, developers will have to become familiar with the assembly language of the target processor, and will become dependent upon the development tools provided for that processor.

Lack of modularity coupled with the fact that the infrastructure code is not reused means that much the same work will have to be redone for the next digital broadcast stack to be produced.

Coupled with these difficulties are an associated set of ‘strategic’ problems that arise from this type of approach to stack development, in which stacks are inevitably strongly attached to a particular hardware environment, namely:

From the stack producer's point of view, there is an uncomfortably close relationship with the chosen DSP hardware platform. Not only must this be selected carefully since mistakes will require a costly (and time-consuming) port, but the development tools, low-level assembly language, test ‘rack’ hardware development and final platform ASIC production will all be architecture-specific. If an opportunity to use the stack on another hardware platform comes up, it will first have to be ported, which will take quite a long time and introduce multiple codebases (and thereby the strong risk of platform-specific bugs). The code base is the source code that underpins a project. Ideally when developing software you would have a one to one mapping between source code and functionality, so if a number of projects require a particular function they would all share the same implementation. Thus, if that implementation is improved all projects will benefit. What tends to happen, however, is that separate projects have separate copies of the code and over time the implementations diverge (rather like genes in the natural world). When projects use different hardware, under the conventional development paradigm, it is sometimes impossible to use the same code. And even if the same hardware platform becomes available with an upgraded specification, the code will still have to undergo a ‘mini-port’ to be able to use those additional features (more on-board memory, for example, or a second MAC (Multiply Accumulate) unit).

From the hardware producer's point of view, there is an equally uncomfortably close relationship with the software stacks. Hardware producers do not want (on the whole) to become experts in the business of stack production, and yet without such stacks (to turn their devices into useful products) they find themselves unable to shift units. For the marketplace, the available ‘software base’ can obscure the other features upon which the hardware producer's products ought more properly to compete (such as available MIPs, power consumption, available hardware IP, etc.).

Operating system providers (such as Symbian Limited) find it essential to interface their OS with baseband communications stacks; in practice this can be very difficult to achieve because of the monolithic, power hungry and real-time requirements of conventional stacks.

Reference may be made to eXpressDSP Real-Time Software Technology from Texas Instruments Incorporated. This suite of products enables the reduction of development and integration time for DSP software. But it exemplifies many of the disadvantages of conventional design approaches since it is tied exclusively to the Texas Instruments DSP platform. Further detailed differences of one implementation of the present invention over the eXpressDSP Real-Time Software Technology suite are summarised in the Detailed Description.

### SUMMARY OF THE PRESENT INVENTION

In accordance with a first aspect of the present invention, there is provided a method of designing, modelling or fabricating a communications baseband stack, comprising the steps of:

(a) creating a description of one or more of the following parameters of the baseband stack:

(i) resource requirements;

(ii) capabilities;

(iii) behaviour; and

(b) using that description as an input to software comprising a virtual machine layer optimised for a communications DSP in order to generate an emulation of the baseband stack to be designed, modelled or fabricated.

Hence, the present invention contemplates (i) applying a form of ‘emulation’ to the domain of communications baseband stack design and (ii) introduces the idea of using a virtual machine layer optimised for a communications DSP in this context. This approach makes accurate simulation of resource utilisation (e.g. processor requirements, peak resource situations, state considerations etc.) possible. The term ‘emulation’ used in this specification should be broadly construed in this context to include any process which enables a system (whether hardware or software) to behave in the same or a similar way to another system (whether hardware or software). Modifications and refinements can be made at an early design stage with the present invention, improving design quality, reducing the chance of costly design errors and reducing overall time to market.

Preferably, the method includes the following stages:

(a) using, for one or more components to be incorporated in the baseband stack, a component description which defines some or all of the externally visible attributes of a component, as well as its behaviour, as an input to a mathematical modelling tool programmed to output component related performance data for each component;

(b) processing the component related performance data for each component to yield a baseband stack description;

(c) creating a resources description defining the resources of the baseband stack;

(d) creating an interface description defining how each component is to used in the baseband stack; and

(e) using each of the baseband stack description, the resources description, and the interface description as the inputs to the software.

The software can therefore emulate accurately the baseband stack; it can also be both instrumented and interpreted/compiled to output diagnostic information in respect of a component in the same format as (e.g. in order to merge with) the component description for that component in order to refine the quality of the component description. This feedback loop can be very effective in rapidly extracting accurate data and feeding it back into the design loop.

Another advantage of this structured approach is that hardware components can be progressively introduced into a test system: a first test may be carried out using software to emulate a given hardware component as part of a design or modelling process; the emulated component is then replaced with the hardware component, and a further test is carried out. Problems and unexpected consequences of using hardware components can therefore be more readily identified. In the same way, ports of individual stack modules can be made to a particular architecture and tested: for example, imagine a baseband stack comprising modules A, B and C: once fully tested in a software emulation, module A can be ported onto the target DSP and the system re-tested, with module A running on the target DSP and modules B and C continuing to run on the emulator. Problems can therefore be more readily identified and resolved.

In addition to emulating the baseband stack, the method can be used to fabricate an actual baseband stack implementation (i.e. generate executable code running on the target platform) by compiling automatically generated source code.

The method of the present invention may utilise a standardised description of the characteristics (including non-interface behaviour) of communications components to enable the emulation to accurately estimate the resource requirements of a system using those components. This is referred to as the Component Definition Language—(‘CDL’) in the embodiment described in the Detailed Description. Communications components are conventionally described with a variety of ad hoc labels. This renders any systematic approach to simulation impossible. Using the standardised description system, component developers will be able to publish their component specifications for potential developers to make use of. Product developers will be able to benchmark their solution using a number of potential suppliers simply by plugging in different data files. It will also be possible for a system builder to calculate, through repeated simulation or mathematically, the ideal specifications of the components they want. Once they have completed this process they will be able to approach potential suppliers armed with precise details of what they require.

Further, the method of the present invention may also utilise a language designed to define completely the functionality of a baseband stack (e.g. receiver/transceiver) to estimate, simulate or fabricate a real device using the above design process. This is referred to as the Device Definition Language—(‘DDL’) in the embodiment described in the Detailed Description. This leads to many advantages: Currently, defining the functionality of a receiver/transceiver is often done in a non-systematic ad hoc manner. DDL however allows the exchange of information between any number of diverse applications, design tools and visualisers. It will also be architecture independent and provide a reliable medium of exchanges between individuals, companies etc. The language will be extensible to allow it to incorporate innovations in the future and so that third parties can incorporate their own components.

At this point, some further elaboration on the meaning of a ‘virtual machine layer’ is appropriate. A ‘virtual machine’ typically defines the functionality and interfaces of the ideal machine for implementing the type of applications relevant to the present invention. It typically presents to the using application an ideal machine, optimised for the task in hand, and hides the irregularities and deficiencies of the actual hardware. The ‘vial machine’ may also manage and/or maintain one or more state machines modelling or representing communications processes. The ‘virtual machine layer’ is then software that makes a real machine look like this ideal one. This layer will typically be different for every real machine type. A ‘virtual machine layer’ typically refers to a layer of software which provides a set of one or more APIs (Application Program Interfaces) to perform some task or set of tasks (e.g. digital signal processing) and which also owns the critical resources that must be allocated and shared between using programs (e.g. resources such as memory and CPU).

The virtual machine layer in an implementation of the present invention is preferably optimised to allocate, share and switch resources in such a way as is best for digital signal processing; a typical operating system, in contrast, will be optimised for general user-interface programs, such as word processors. Thus, for example, the resource switching algorithms in this case will typically operate on much smaller time increments than that of an end-user operating system and may control parallel processes.

The virtual machine layer, optimised for a communications DSP, insulates software baseband stacks from the hardware upon which they must execute. Hence, baseband stacks can be made very portable since they can be isolated by the virtual machine layer from changes in the underlying hardware. The virtual machine layer may also manage flow control between different connected modules (each performing different functions); this may be done on a concurrent basis. It may also define common data structures for signal processing, as will be described in more detail subsequently.

The software of the present invention may be used in a development environment to enable a communications device, (e.g. a baseband stack, or indeed an entire SoC including several baseband stacks from different vendors, or an end product such as a mobile telephone) to be modelled and developed or to actually perform baseband processing.

The potency of applying the ‘virtual machine layer’ concept to the domain of communications DSPs can best be understood through an example from a non-analogous field. In the field of PC software, Microsoft's Windows™ operating system (sitting on top of the system BIOS) insulates software developers from the actual machine in use, and from the specifics of the devices connected to it. It provides, in other words, a ‘virtual machine layer’ upon which code can operate. This is schematically illustrated in FIG. 1. Because of this virtual machine layer, it is not necessary for someone writing a word processor, for example, to know whether it is a Dell or a Compaq machine that will execute their code, or what sort of printer the user has connected (if any). Furthermore, the operating system provides a set of common components, functions and services (such as file dialog panels, memory allocation mechanisms, and thread management APIs). Because only written once, the rigour, extent and reliability of such ‘common code’ is greatly increased over what would be the case if each application had to re-implement it, over and over again. Further, the manufacturers of PC hardware are protected from the complexities of software development, having only to provide a BIOS and drivers from the appropriate Windows APIs in order to take advantage of the vast array of existing software for that platform. This situation can be contrasted with the pre-Windows situation in which each application would frequently contain its own custom GUI code and drivers, as illustrated in FIG. 2.

A key enabler for the PC Windows ‘virtual machine layer’ approach is that a large number of applications require largely the same underlying ‘virtual machine’ functionality. If only one application ever needed to use a printer, or only one needed multithreading, then it would not be effective for these services to be part of the Windows ‘virtual machine layer’. But, this is not the case as there are a large number of applications with similar I/O requirements (windows, icons, mice, pointers, printers, disk store, etc.) and similar ‘common code’ requirements, making the PC ‘virtual machine layer’ a compelling proposition.

However, prior to the present invention, no-one had considered applying the ‘virtual machine’ concept to the field of communications DSPs; by doing so, the present invention enables software to be written for the virtual machine rather than a specific DSP, decoupling engineers from the architecture constraints of DSPs from any one source of manufacture. This form of DSP independence is as potentially useful as the hardware independence in the PC world delivered by the Microsoft Windows operating system. It is illustrated schematically in FIGS. 3 and 4. FIG. 3 shows a conventional situation in which parts of the baseband stack which should, when properly implemented, be architecturally neutral are in fact not properly isolated from the substrate hardware; FIG. 4 depicts how the virtual machine layer (called the Communications Virtual Machine or CVM of the present invention does successfully isolate these parts of the baseband stack.

There are therefore several key advantages to the CVM:

Porting baseband stacks across DSP architectures and to different media access hardware (such as, for example, porting a stack for a GSM phone operating at 900 MHz to one operating at 1800 MHz) will be much faster since the invention enables stacks to be designed which are not architecture or spectrum specific: a critical advantage as time to market becomes ever more important. Hence, a stack will work on any DSP architecture to which the virtual machine layer has been ported. Likewise, a DSP to which the virtual machine layer has been ported will run all the stacks written for the virtual machine layer.

Much of the high MIPS, complex code (e.g. a Viterbi decoder) will be written once only for the virtual machine layer, as opposed to many different times for each DSP architecture. Hence, quality and reliability of this complex code can be economically improved. That in turn means that the baseband stacks will themselves need less code and what stack code there is need be less complex, thus increasing its reliability.

The virtual machine layer provides the ability to prototype either entirely in software or with a mixture of software and proven DSP components, allowing the identification of algorithmic deficiencies and resource requirements earlier in the development cycle.

Preferably, the virtual machine layer is programmed with or enables access to various core processes and/or core structures and/or core functions and/or flow control and/or state management. The core processes with which the virtual machine layer is programmed (or enables access to) include one or more ‘common engines’. These ‘common engines’ perform one or more of the baseband stack functions, namely: source coding, channel coding, modulation and their inverses (source decoding, channel decoding and These two libraries, no matter what the underlying hardware and operating system substrate, are manifest as a common API to the ‘core’ code, which therefore does not have to be modified during a port. The only code which does get modified, namely the contents of the library implementations, benefits from significant encapsulation and a wide variety of test vectors generated from the mathematical models. It is because the points of articulation in the architecture are appropriately positioned that porting of stacks can be rapidly achieved using this approach.

Furthermore, as a development platform, this approach has the great advantage that one can develop on one architecture (e.g. the Intel platform) running not a mathematical model but rather a full, real-time transceiver, and then simply swap the libraries and recompile on the target architecture. This is very useful when trying to e.g., tune an equaliser module.

The CVM approach builds on this way of working. However, in addition, as much as possible of the common functionality is abstracted into the ‘virtual machine’ hardware abstraction layer, together with key services and functions that are useful for all digital communications baseband processing work.

FIG. 7 below shows how this would work at an architectural level. Instead of the given stack being shipped with different library implementations for platform A and platform B, in the CVM there is a common ‘baseband operating system’ layer for each of platform A and platform B, providing a common API on top of which (apart from a recompile) the higher level code can run unchanged.

Furthermore, we can incorporate into this layer much of the functionality that otherwise would lie within the C++ core, such as the symbol subscriber architecture for symbol-directed processing, and the pipeline architecture for data directed processing.

Specific CVM Development Methodologies: Two Phase Scheduling

Phase I

An important aspect when building a Baseband communications system is quantifying the requirements of the hardware and software platform the application will run on. A baseline calculation of the number of MIPs (millions of instructions per second) an application will require is relatively straight forward, simply calculate the requirements of each component to perform one operation, multiply by the number of operations and add them all together. This, however does not take into account aspects like parallelism. Although, theoretically, 2×500 MIPs processors will deliver 1000 MIPs of processing power the algorithms may not be able to take advantage of this if the are waiting for operations on another chip to complete. There are also the extra processing requirements of the scheduler and the data transfer overheads to consider. The data transfer penalty is probably small if both processors are on the same board but more significant if they are on separate boards plugged into an external bus. Bus contention (two or more processors wanting to transfer data at the same time) can also reduce overall efficiency.

The CVM provides a number of methods to facilitate implementing systems in this sort of distributed environment.

Initially we can quantify the requirements of the individual computing components such as the signal processing functions described in Appendix 1 and the more application specific engines built upon them. In environments like 3G mobile communications the amount of data passing though a block will vary over time so it is not sufficient just to calculate the requirements of a block at one data rate. Instead a profile will be built up over the range of potential input vector sizes.

The CVM allows a system to be defined as a collection of data flows (pipelines) where data is injected at one end, and consumed at the other. The engines on these pipelines are characterised in terms of how much processing they require as a function of input vector size. The first pass at calculating the MIPs usage is to simulate passing engines of varying size along this pipeline and calculating the total usage as a function of input block size. This calculates the total MIPs requirements of the engines assuming they are run sequentially to completion on a single processor.

A more sophisticated model then assigns engines to separate processors and allows true pipelining. A solution based on this architecture will require more MIPs than the single threaded solution but has the potential, once the pipeline is loaded, to process data engines in shorter elapsed time. If N is the number of processors, E(N) the efficiency of processor utilisation (1=100%, 0=zero), Mp the MIPs rating of a single processor and M the total MIPs requirement of the problem then the time to process 1 seconds worth of data T will be;

T=M/(E(N)×N×Mp)

The objective is to find the smallest value of N where T is less than 1 by a “comfortable” margin. E(N) will be close to 1 for a single board and will drop as the number of boards is increased (because of the overheads introduced by scheduling and data transfer). E(N) will also vary depending on how the processing engines are distributed between the boards (because of the varying data transfer requirements and the possibility of uneven load balancing leaving an processor idle some of the time).

A CVM simulator that has knowledge of the scheduling process, the characteristics of the bus and the characteristics of the engines will be able to calculate E(N) and hence T for different numbers of boards and engine arrangements. It will also be possible to investigate the effects of “doubling up” some of the engines; that is having the same functionality on more than one board.

Once we know the sequence of engines that are required for a task we can set the CVM to search through arrangements of engines and boards looking for the optimal solution. It will also be possible to have individual Mp values for the boards (replace N×Mp by the sum of the individual Mps) and to tie specific engines to specific boards, for instance a Viterbi decoder will always run on an FPGA, which will have a higher MIPs rating than a DSP. For large numbers of engines exhaustive searches will become impractical and some assistance from an engineer will be required.

Phase II

Once we have and acceptable arrangements of engines and boards we can move onto phase two of the scheduling process, “doing it for real”. Phase I will have generated a system configuration which can no be used to load the engines onto the correct boards. This information will also be made available to the scheduler on the main board. Once the system is running data engines will flow from the scheduler to the engines that will operate on them. Most of the time this scheduler will simply send data onward in the order they need to be processed but there will be occasions when more intelligence can be applied. When there are multiple engines of equivalent priority the scheduler will look to try and balance the queue sizes on all the boards by scheduling work to the least loaded. When the same functionality exists on more than one board the scheduler will again look for the most appropriate board to schedule. All the boards will have a local scheduler to obviate the need to involve the main scheduler in routing engines between two engines on the same board. When there is a choice of board to send work to schedulers will always choose their own board when possible. The scheduler will also have to monitor the absolute urgency of the most urgent engines looking for potential lulls in the processing when it can schedule less urgent activities, such as routing log messages and monitoring information back to a monitoring console.

More CVM Development Methodologies: the MIPS Counter as Used in a UMTS Implementation

As noted above, the CVM consists of a number of distributed engines that are connected and controlled by the CVM Scheduler. These engines may sit on the same hardware, but could sit on different hardware (CPU, DSP or FPGA.) For a UMTS implementation of the CVM, a system to identify bottlenecks and aid in serialisng the engines/blocks has been developed. We first assume that the processing route for a block of data is given; for instance the UMTS standards 25.212 and 25.222 suggest how the block is muxed in the TrCH stage. Some of the processing may then be switched between routes depending on some objective criteria such as BER. However, the required engines are known. Then, the order of the engine must be determined in terms of the data size and number of users. For example, if a vector is of length n, and if the engine consists of for (int i=0,i<n, i++)

{

for (int j=0,j<n, j++)

{

//Do something . . .

}

}

then we can say that the process is an order nˆ 2, or o(nˆ 2). Next we can count the number of operations (‘+’, ‘−’, . . . in (//Do something’). FFTs are for example n Log (n) processes. We can then multiply this by the device's instructions per operation and then divide this by the number of MIPS to get the time that the device will take to perform a task. Alternatively we can simply set a relative time.

The same process can be repeated for the number of users (K): for example MU can go as 2ˆ K. Finally, each block may or may not change the bit rate. Turbo Encoding increases it multiplicatively by a factor of 3.m CRC adds 12 bits. Note, that bus latency, the scheduler, parallelisation/serialisation can all be considered to be engines).

The point is that we know that data rate. The question answered by this process is how we can distribute the engines (e.g. their MIPS budget) to accommodate this.

TopDownDesign

Traversing the processing chain is quite complex when state and data control are needed. This procedure is used to tie in RS C++ blocks through a standard adaptor to integrate with Simulink. Fundamentally, the intention is to move through hierarchies. As you move up layers, so the abstraction becomes higher and higher. The intention is to round trip data a ‘user’ creates 3 services: The UE Tx this to the BS through a physical channel with certain properties. The BS receives and decodes the data. In this case the BS has a trivial backhaul, and retransmits the data back to the UE, through a physical channel, whereupon the data is compared to the input data. This system allows us to interchange engines to improve performance in terms of BER and time in a variety of channels.

CVM Features

The CVM can be thought of as a minimal OS to provide the sorts of functionality required by baseband processing stacks (and, as mentioned, these can be two-way stacks also, such as GSM or Bluetooth). It is therefore complementary to a full-blown embedded operating system like Microsoft Windows CE or Symbian's EPOC.

The CVM provides (inter alia) the following functionality:

Extensive set of vector-processing primitives (more completely listed at Appendix 1), covering operations such as FFTs, FIR and IIR and wave digital filters, decimation, correlation, complex multiplication, etc. These should use hardware acceleration where this is available on the underlying hardware, and would be accessed via a set of library calls paralleling an extended version of a library. In a sense, this aspect of the CVM represents a software or API abstraction of an idealised digital signal processing engine for digital communications.

Support for allocation of aligned buffers and memory ‘handshaking’ (ping-pong buffers).

Advanced scheduling management, with the option for pre-emptive multithreading of a simple kind. Hard real-time performance (i.e., the ability to guarantee that a piece of code will execute at a particular point in time) will be supported as a key component of the architecture. Inter-process communication structures (at least shared memory) and thread synchronisation facilities will be provided. A key feature is a stochastic parallel scheduler, cognisant of design time pardoning decisions for CVM engines across a heterogenous computational substrate.

Explicit support for the notion of symbol and data directed processing. This will directly support the ability to add symbol subscribers and pipeline stages into the structure to allow modular development.

Support for key I/O peripherals, including serial ports, parallel ports and display controllers.

Extensibility to enable the scope of the O/S to be increased, particularly for modular I/O support.

Characterisation libraries for a particular implementation, allowing mathematical models and real-time prototypes to mimic the performance of the target substrate and interconnects to a high degree of accuracy.

PC versions to enable the production of real-time prototypes.

Support for communication with a host (application) OS—this will be bidirectional to enable callbacks and so on. A component intercommunication technology (e.g. COM) may be used to provide the binary ‘glue’. A suitable application OS might be, for example, EPOC32 or Windows CE, as these are OSs designed to perform the more usual user-level I/O and structured storage management demodulation). The ‘common engines’ include the fast Fourier transform (FFI), Viterbi decoder (with various constraint lengths, Galois polynomials and puncturing vectors), Reed-Solomon engines, discrete cosine transform (DCT) for the MPEG decoders, time and frequency bitwise re-ordering for error decoherence, complex vector multiplication and Euler synthesis. A more extensive list is contained at Appendix 1. One or more of these parameterised transforms are commonly required by communications baseband stacks. This subsidiary feature is predicated on the inventive insight that a set of common processes is found within almost all of the key digital broadcast systems; an example is the similarity of GSM to DAB: both, for example, use interleaving and Viterbi decoding. Commonality is hence predicated on a common mathematical foundation.

In addition, a ‘core structure’ may also be present in each case. The ‘core structure’ involves splitting the decoding chain up into a symbol processing section (concerned with processing full symbols, regardless of whether all the information held within that symbol is to be used) and data directed processing, in which only those bits which hold relevant information are processed. In each case, it is highly desirable that the processing modules are able to allocate, share and dispose of intermediate, aligned memory buffers, pass events between themselves, and exist within a framework that enables modular development.

The core function may relate to resource allocation and scheduling, include one or more of the following: memory allocation, real time resource allocation and concurrency management.

The software can preferably access PC debug tools, which are far superior in performance and capability than DSP design tools. It may be subject to conformance scripting, as will be defined subsequently. In addition, it may operate with a component, in which only that information necessary to enable it to operate with and/or otherwise model the performance of the component is supplied by the owner of the intellectual property in the component. This enables the owner of the intellectual property (which can be valuable trade secret information such as internal details, design and operation) to hide that information, releasing only far less critical information, such as the functions supported, the parameters required the APIs, timing and resource interactions, and the expected performance for characterisation estimation.

Since the CVM draws together the ideas introduced above, and is a critical aspect of an implementation of the present invention, it is summarised in the following section.

Summary of the CVM Implementation

The CVM is both a platform for developing digital signal processing products and also a runtime for actually running those products. The CVM in essence brings the complexity management techniques associated with a virtual machine layer to real-time digital signal processing by (i) placing high MIPS digital signal processing computations (which may be implemented in an architecture specific manner) into ‘engines’ on one side of the virtual machine layer and (ii) placing architecture neutral, low MIPS code (e.g. the Layer 1 code defining various low MIPS processes) on the other side. More specifically, the CVM separates all high complexity, but low-MIPs control plane and data ‘operations and parameters’ flow functionality from the high-MIPs ‘engines’ performing resource-intensive (e.g., Viterbi decoding, FFT, correlations, etc.). This separation enables complex communications baseband stacks to be built in an ‘architecture neutral’, highly portable manner since baseband stacks can be designed to run on the CVM, rather than the underlying hardware. The CVM presents a uniform set of APIs to the high complexity, low MIPS control codes of these stacks, allowing high MIPS engines to be re-used for many different kinds of stacks (e.g. a Viterbi decoding engine can be used for both a GSM and a UMTS stack).

The CVM can form part of a design tool which can support stochastic simulation of load on multiple parallel datapaths (distribution to underlying ‘engines’ of the virtual machine) where the effect of the distribution of these datapaths to different positions within a potentially heterogenous communications DSP topology or a non-symmetric memory topology (e.g., some components being local, others accessible across a contested bus, etc) may be explored with respect to expected loading patterns for given precomputed scenarios of use. The output of such a design tool is an initial partitioning of the design ‘engines’ (high-MIPs components) into variously distributed ‘hard’ and ‘soft’ datapaths (where a hard datapath is a flow implemented in an ASIC or FPGA, and soft datapath is a flow implemented over a conventional programmable DSP). This partitioning is visible to the dynamic scheduling engine (by means of which the high level, architecture neutral software dispatches its processing requests to the underlying engines) and is utilised by it, to assist in the process of making optimal or close to optimal runtime scheduling decisions.

During the development stage of a digital signal processing product, the MIPS requirements of various designs of the digital signal processing product can be simulated or modelled by the CVM in order to identify the arrangement which gives the optimal access cost (e.g. will perform with the minimum number of processors); a resource allocation process is used which uses at least one stochastic, statistical distribution function, as opposed to a deterministic function. Simulations of various DSP chip and FPGA implementations are possible; placing high MIPS operations into FPGAs is highly desirable because of their speed and parallel processing capabilities.

During actual operation, a scheduler in the CVM can intelligently allocate tasks in real-time to computational resources in order to maintain optimal operation. This approach is referred to as ‘2 Phase Scheduling’ in this specification. Because the resource requirements of different engines can be (i) explicitly modelled at design time and (ii) intelligently utilised during runtime, it is possible to mix engines from several different vendors in a single product. As noted above, these engines connect up to the Layer 1 control codes not directly, but instead through the intermediary of the CVM virtual machine layer. Further, efficient migration from the non-real time prototype to a run time using a DSP and FPGA combination and then onto a custom ASIC is possible using the CVM.

The CVM is implemented with three key features:

Dynamic, multi-memory-space multiprocessor distributed scheduler with support for co-scheduling.

APIs to commonly used, high-MIPs operations for digital broadcast and communications, with architecture-native implementations.

Resource management and normalisation layer (provided over the native RTOS).

The CVM can exist in several ‘pipeline’ forms. A ‘pipeline’ is a structure or set of interoperating hardware or software devices and routines which pass information from one device or process to another. In the DSP environment, such pieces of information are often referred to as ‘symbols’. Pipelines can be implemented also as data flow architectures as well as conventional procedural code and all such variants are within the scope of the present invention. The CVM can also be conceptualised and implemented as a state machine or as procedural code and again all such variants are within the scope of the present invention.

One instance of the CVM contains an Interpreted Pipeline Manager, which incorporates run-time versions of the CVM core. By ‘interpreted’ we mean that its specification has not been translated into the underlying machine code, but is repeatedly re-translated as the program runs, in exactly the same was as an interpreted language, such as BASIC.

Another instance is an Instrumented Interpreted Pipeline Manager which incorporates run-time versions of the CVM core. This operates in the same was as an Interpreted Pipeline Manager, but also produces metrics and measurements helpful to the developer. An interpreted non-instrumented version is also useful for development and debugging, as is a compiled and instrumented version. The latter may be the optimal tool for developing and debugging.

Another version of the CVM is a Pipeline Builder. Instead of running, it outputs computer source code, such as C, which can be compiled to produce a Pipeline implementation. For this reason it must have available to it CVM libraries. It can be thought of as the compiled and non-instrumented variant.

The CVM apparatus may include or relate to a standardised description of the characteristics (including non-interface behaviour) of communications components to enable a simulator to accurately estimate the resource requirements of a system using those components. Time and concurrency restraints may be modelled in the CVM apparatus, enabling mapping onto a real time OS, with the possibility of parallel processing.

Other features and aspects of the present invention are defined in the Claims of this specification.

### BRIEF DESCRIPTION OF THE DRAWINGS

The invention will now be described with reference to the accompanying drawings in which:

FIG. 1 is a schematic showing the relationship between hardware and application software when using Microsoft Windows;

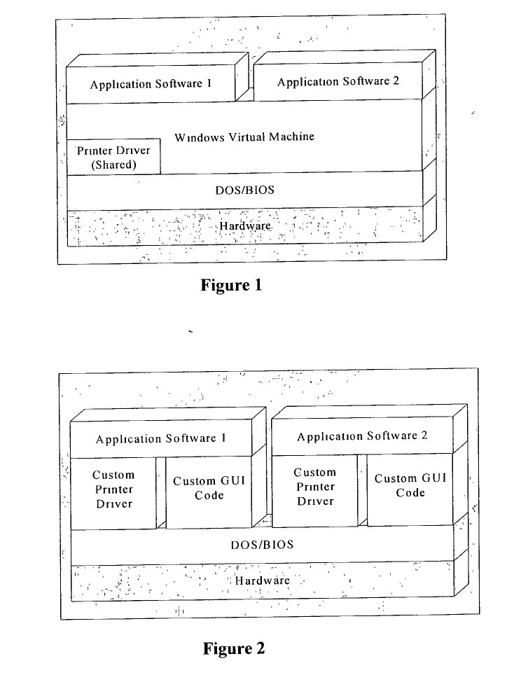

FIG. 2 is a schematic showing the pre-Microsoft Windows relationship between hardware and application software;

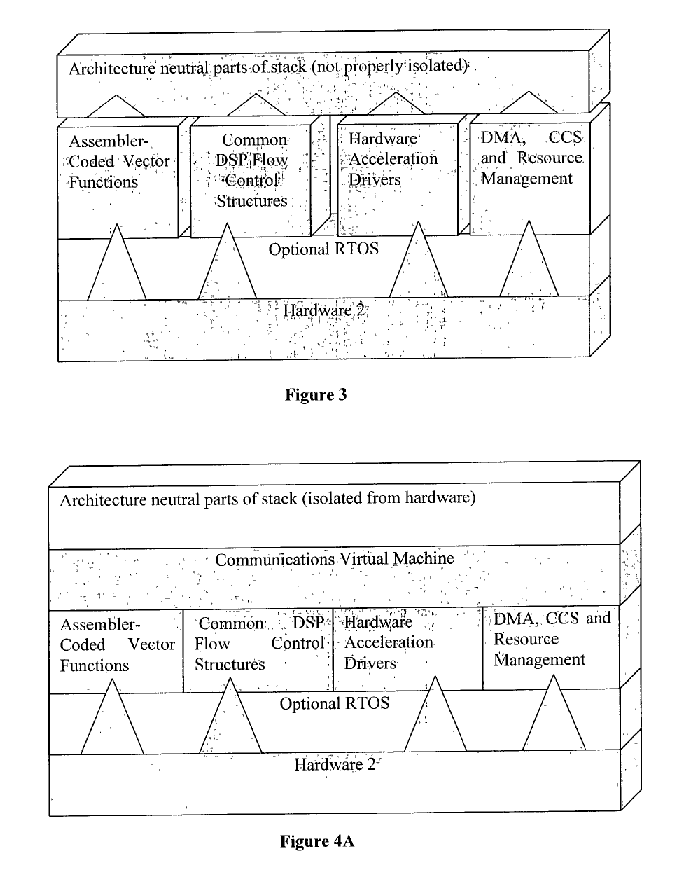

FIG. 3 is a schematic showing the conventional failure to isolate supposedly architecturally neutral parts of a baseband stack;

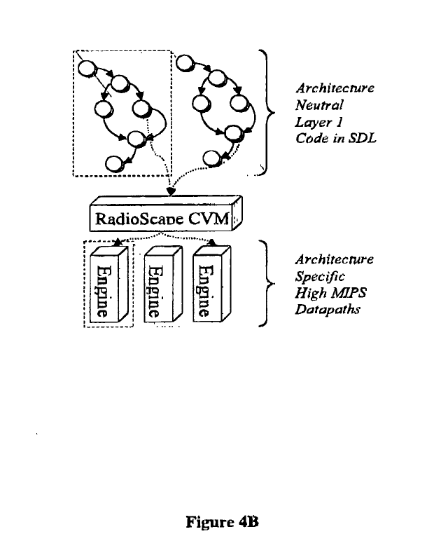

FIGS. 4A and 4B are schematics showing the successful isolation of architecturally neutral parts of a baseband stack in the present invention;

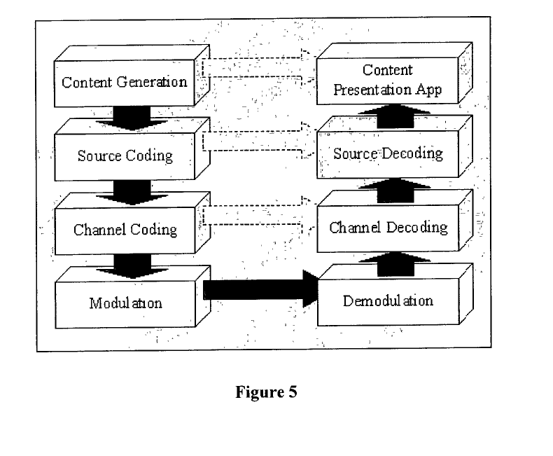

FIG. 5 is a schematic showing the structure in a baseband communications stack;

FIG. 6 is a schematic showing the common engines and structure in an embodiment of the present invention;

FIG. 7 is a schematic showing the relationship between the CVM of the present invention, the hardware and the stack;

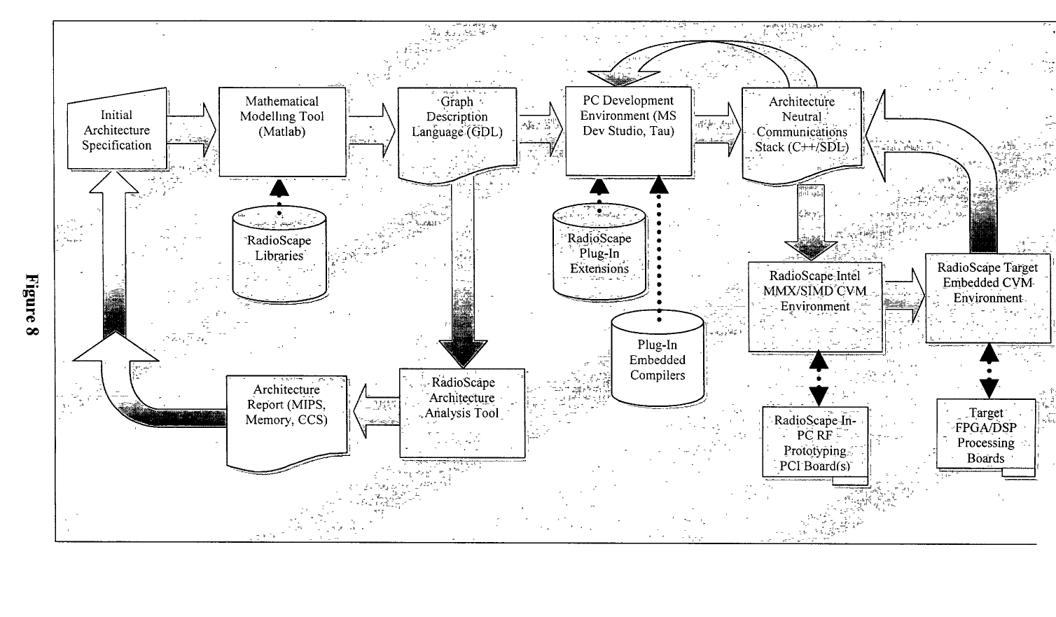

FIGS. 8 and 9 are schematics showing steps in the development cycle using the present invention.

### DETAILED DESCRIPTION

The present invention will be described with reference to the CVM implementation from RadioScape Limited of London, United Kingdom.

CVM Overview

The CVM is both a platform for developing digital signal processing products and also a runtime for actually running those products. The CVM in essence brings the complexity management techniques associated with a virtual machine layer to real-time digital signal processing by (i) placing high MIPS digital signal processing computations (which may be implemented in an architecture specific manner) into ‘engines’ on one side of the virtual machine layer and (ii) placing architecture neutral, low MIPS code (e.g. the Layer 1 code defining various low MIPS processes) on the other side. More specifically, the CVM separates all high complexity, but low-MIPs control plane and data ‘operations and parameters’ flow functionality from the high-MIPs ‘engines’ performing resource-intensive (e.g., Viterbi decoding, FFT, correlations, etc.). This separation enables complex communications baseband stacks to be built in an ‘architecture neutral’, highly portable manner since baseband stacks can be designed to run on the CVM, rather than the underlying hardware. The CVM presents a uniform set of APIs to the high complexity, low MIPS control codes of these stacks, allowing high MIPS engines to be re-used for many different kinds of stacks (e.g. a Viterbi decoding engine can be used for both a GSM and a UMTS stack).

The virtual machine layer supports underlying high MIPs algorithms common to a number of different baseband processing algorithms, and makes these accessible to high level, architecture neutral, potentially high complexity but low-MIPs control flows through a scheduler interface, which allows the control flow to specify the algorithm to be executed, together with a set of resource constraint envelopes, relating to one or more of: time of execution, memory, interconnect bandwidth, inside of which the caller desires the execution to take place.

During the development stage of a digital signal processing product, the MIPS requirements of various designs of the digital signal processing product can be simulated or modelled by the CVM in order to identify the arrangement which gives the optimal access cost (e.g. will perform with the minimum number of processors); a resource allocation process is used for modelling which uses at least one stochastic, statistical distribution function (and/or a statistical measurement function), as opposed to a deterministic function. Simulations of various DSP chip and FPGA implementations are possible; placing high MIPS operations into FPGAs is highly desirable because of their speed and parallel processing capabilities.

During actual operation, a scheduler in the CVM can intelligently allocate tasks in real-time to computational resources in order to maintain optimal operation. This approach is referred to as ‘2 Phase Scheduling’ in this specification. Because the resource requirements of different engines can be (i) explicitly modelled at design time and (ii) intelligently utilised during runtime, it is possible to mix engines from several different vendors in a single product. As noted above, these engines connect up to the Layer 1 control codes not directly, but instead through the intermediary of the CVM virtual machine layer. Further, efficient migration from the PCT non-real time prototype to a run time using a DSP and FPGA combination and then onto a custom ASIC is possible.

The CVM is implemented with three key features:

Dynamic, multi-memory-space multiprocessor distributed scheduler with support for co-scheduling.

APIs to commonly used, high-MIPs operations for digital broadcast and communications, with architecture-native implementations.

Resource management and normalisation layer (provided over the native RTOS).

The CVM is a Design Flow Solution as Well as a Runtime

The CVM provides a complete design flow to complement the runtime. This provides the engineer with fully integrated mathematical models, statistical simulation tools (essential for operation with bursty data), a priori partitioning simulation tools (to determine e.g., whether a datapath should go into hardware or run in software on a DSP core). Through the use of custom libraries for mathematical modelling tools (e.g. Matlab/Simulink), the CVM is able to model in detail and with bit-exact accuracy the high-MIPs engine operations, allowing engineers to determine up front how many bits wide the various datapaths must be, etc. However, the system is also able to accept XML commands from a statistically simulated control plane, allowing birth/death events and burstiness to be handled within the context of the model. Furthermore, since even the simulation engines are accessed through the scheduler's indirection interface, it is possible to plug in calls to e.g. real hardware implementations to speed simulation execution.

It is also, importantly, possible to perform simulation of resource loading under various system partitioning decisions. How many instances of a particular algorithmic ‘engine’ (e.g., a Viterbi decoder, a RAKE receiver element, a block FFT operation, etc.) are required to provide sufficient cover under various statistical loadings? What happens if a datapath is moved across a latent and/or contended resource such as a bus? What if the datapath is implemented in hardware rather than software? All of these decisions are critical but existing toolsets have not addressed them, and this is doubly true when the partitioning decisions are being made with respect to multiple, third-party IP engines or engines (see below). The CVM design flow explicitly enables these sorts of design decisions to be answered. Furthermore, initial partitioning information is then ‘fed forward’ from the design toolset into the runtime scheduler, enabling it to vector requests off to the appropriate engine instances for implementation when the system is under actual dynamic load.

Working from the ‘bottom up’, treating the software largely as an afterthought, is not longer a viable route to market; this path simply takes too long, yields a result that is too architecture-specific, and has a bad ‘fit’ to the parallel, state-machine nature of the underlying domain. Working from the ‘top down’, the paradigm utilised by the CVM, provides a much more powerful and extensible solution.

A final point about the CVM is that by separating out the control flow code from the underlying engines, it becomes possible to perform a lot of development work on conventional platforms (e.g., PCs) without having to work with the actual embedded target. This allows for much faster turnaround of designs than is generally possible when using a particular vendor's end target development platform.

### EXAMPLE

The CVM is a Design Solution for Hard Real Time, Multi-vendor, Multi-protocol Environments Such as SoC for 3G Systems

One of the core elements of the CVM is its ability to deal with (potentially conflicting) resource requirements of third party software/hardware in a hard real time, multi-vendor, multi-protocol environment. This ability is a key benefit of the CVM and is of particular importance when designing a system on chip (SoC). To understand this, consider the problems faced by a would-be provider of a baseband chip for the 3G cellular phone market. First, because of the complexity of the layer 1 processing required, simply writing code for an off-the-shelf DSP is not an option; an ASIC will be required to handle the complexities of dispreading, turbo decoding, etc. Secondly, since UMTS will only be rolled out in a small number of metro locations initially, the chip will also need to be able to support GSM. It is unlikely that the company producing the baseband chip will have extensive skills in both these areas, therefore IP will need to be licensed in. This point becomes particularly relevant in light of the ever increasing time-to-market pressures for technology companies. But licensing in part-hardware, part-software IP engines from multiple vendors for layer 1 provides a real problem. First, there is no current common simple standard for ‘mix and match’ IP in this manner. What is needed, and what the CVM design flow provides, is a way to characterise both the static and dynamic resource requirements of a 3^{rd} party IP block, so that it may be co-scheduled in real time with other IP engines, potentially from an entirely different supplier, and then connected transparently through to the higher level layer 1 control code. Furthermore, the nature of the CVM is that these high-level overall call structures and control planes can be produced in an architecture-neutral language (e.g., SDL compiled to ANSI C), with only the low-level, high-MIPs parts being implemented directly in an architecture-specific form.

As noted above, the high MIPs functionality contained within the engines represent complete operational routines. These engines may be implemented in hardware or software or some combination of the two, but this is unimportant from the point of view of the high level ‘calling’ code, which is entirely abstracted from the engines. The high-level IP communicates with the underlying engines via CVM scheduler calls, which allow the hard real-time dynamic resource constraints to be specified. The scheduler then dispatches the request to the appropriate datapath for execution, which may involve calling a function on a DSP, or passing data to an FPGA or ASIC. Importantly, the scheduler can deal with multiple hard datapaths that may have different access and execution profiles—for example, an on-bus Viterbi decoder, an on-chip software based decoder, and an off-chip dedicated ASIC accessed via external DMA—and pass particular requests off to the appropriate unit, which is completely independent from the calling high-level code.

This also means that, where two different communications stacks require some common high-MIPs engines, a vendor of an appropriate (platform-specific) engine implementation (whether designed in hardware, software, or some combination of both) can sell into both markets, and, if the two standards are implemented on a single SoC, both stacks can potentially share the same accelerator. In addition, the CVM specifies a set of over 100 core operations which taken together provide around 80% of the high-MIPs functionality found in the vast majority of digital broadcast and communications protocols. The CVM runtime also provides a wrapper around the underlying RTOS, presenting the high-level code with a normalised interface for resource management (including threads, memory, and external access).

Using the CVM, it is possible to construct an integrated development platform for communications SoC products, in which a number of third party vendors are able to publish their IP, as either high-level architecture neutral SDL or C++ components, or architecture specific, resource profiled engines (which can be hardware, software, or a combination of both). An integrated design flow would enable the SoC designer to produce an overall system that contains the appropriate engines (chosen from particular vendors), add her own IP on both or either side of the CVM, and then generate both the deployable hardware specification (as a number of VHDL-defined cores, together with accelerators) and software components. It is possible to construct a toolset which would provide a complete flow through mathematical modeling, statistical a priori stochastic simulation for partitioning, protocol verification and final system generation and provide appropriate mechanisms to characterise, publish, enumerate and use libraries of ‘packaged’ IP within designs.

This system would have the potential to become the main workbench for SoC designers, who would only have to go into VHDL tools to develop the high-MIPs engines, not any of the layer 1 control fabric.

The CVM Allows SDL to be Used in Designing Layer 1

As noted above, the CVM allows the low-MIPs code to be written in an architectural neutral manner, using either ANSI C++ or, preferably, SDL which may then be compiled to ANSI C. SDL is a language widely used within the telecommunication industry for the representation of layer 2 and layer 3 stacks, and is particularly well suited to systems that are most economically expressed in a state machine format. SDL traditionally would not be appropriate for use below layer 2 (the end of the ‘soft real time’ domain). The SDL code is entirely portable between various architectures, and may be tested in the normal manner using tools such as TTCN. System constraints (such as dynamic resource ceilings) can be attached to various portions of the code and substrate interconnects in development and then simulated with realistic loading models to allow up-front partitioning of the datapaths into hardware and software. Importantly, the CVM schedule is cognisant of the datapath portioning decisions taken during the design time portion of the development process. The toolflow is fully integrated with Matlab and Simulink, allowing bit-accurate testing of high-MIPs functionality. The use of SDL as the preferred language for the high-level logic flows within layer 1 is not accidental—SDL has been widely used within layers 2 and 3 of telecommunications stacks such as GSM, but has not crossed the chasm into the hard real time domain. With the CVM, by contrast, it becomes possible to invoke parallel, hard real time execution from SDL control flows, thereby allowing the extremely powerful and natural state machine expressiveness of SDL to be used to author the high level layer 1 algorithms. Increasingly, although low MIPs these algorithms are themselves extremely complex, as they must deal with issues such as bursty rate matching, user transport channel birth/death events, handovers between multiple standards, and QoS-bound graceful degradation under load, to name but a few. Other languages not designed for real-time operations (e.g. C++ and Java) can also be used in designing Layer 1, as alternative s to SDL.

Theoretical Background to the CVM

Current digital communications systems are built around a largely common consensus, which has emerged in the last 15 years or so, about the best way to reliably transmit information wirelessly in the face of quite severe channel effects. Two-way systems have somewhat different channel and modulation requirements from broadcast-oriented systems (for example, using CDMA to provide graceful degradation in the face of a congested spectral band, and having some ‘hard’ real time requirements), but overall much commonality exists.

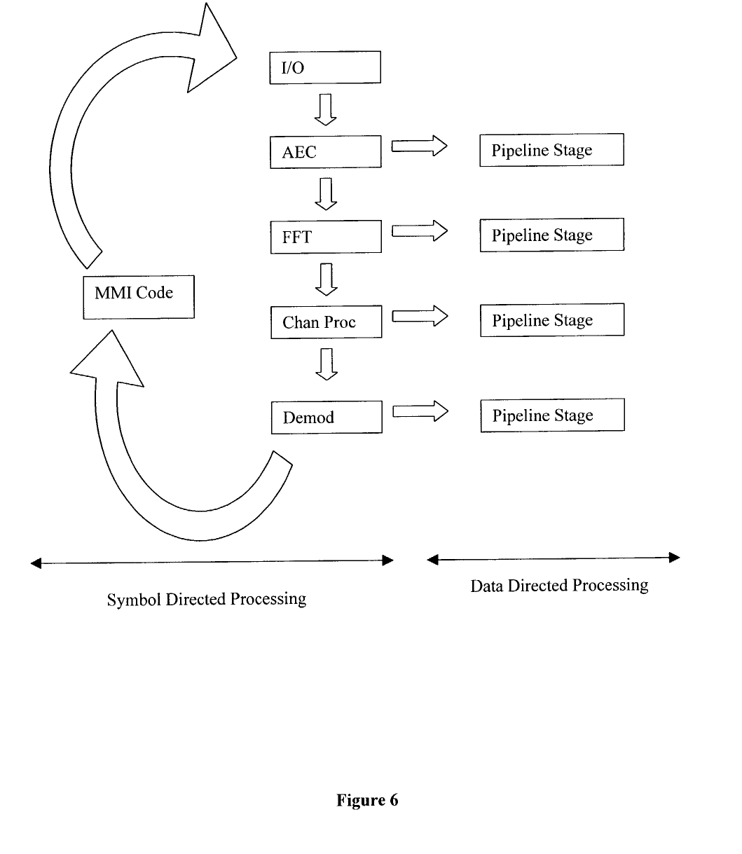

For example, in the specific case of broadcast (one-way) systems, decoders and encoders may be seen as simply parallel ‘protocol stacks’. Most broadcast transmission systems start with source coding (such as MPEG; this compresses the input to reduce bitrate) followed by channel coding (such as convolutional and Reed-Solomon coding; this adds structured redundancy to improve the ability of the receiver to extract information despite signal corruption) followed by modulation (at which point a number of subcarriers are modified in some combination of angle (frequency or phase) or amplitude to hold the information. The reverse process is then carried out in the receiver, yielding (on one level) the diagram of FIG. 5. Hence, a set of common processing engines are found within almost all of the key digital broadcast systems, and a common processing structure may also be applied in each case.

The CVM embodiment exploits this as follows: the common engines, (or functions or libraries) include algorithms to perform one or more of the following: source coding, channel coding, modulation, or their inverses, namely source decoding, channel decoding and demodulation. They include for example, the fast Fourier transform (FFT), Viterbi decoder (with various constraint lengths, Galois polynomials and puncturing vectors), Reed-Solomon engines, discrete cosine transform (DCT) for the MPEG decoders, time and frequency bitwise reordering for error decoherence, complex vector multiplication and Euler synthesis, etc. A more extensive list is at Appendix 1. These are high MIPS routines and therefore ideally implemented in a CVM in an architecture specific manner (either through assembly code or hardware accelerators). They can, regardless of this, be accessed in the CVM through common, high level APIs. Each of these parameterised transforms has a parallel mathematical modelling block provided for it.

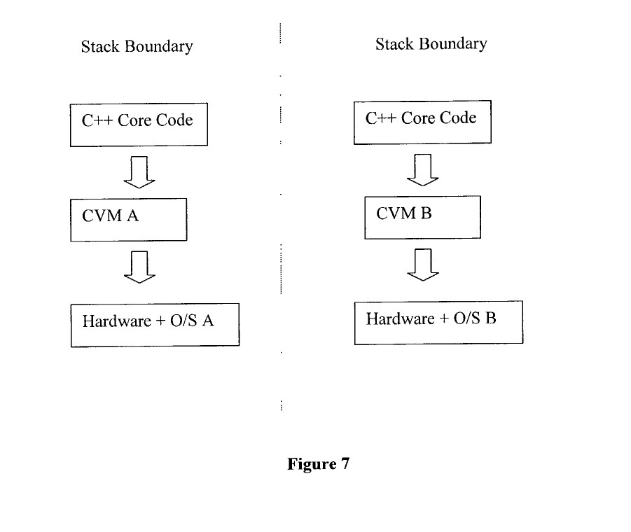

The common structure involves splitting the decoding chain up into a symbol processing section (concerned with processing full symbols, regardless of whether all the information held within that symbol is to be used) and data directed processing, in which only those bits which hold relevant information are processed. In each case, it is critical that the processing modules are able to allocate, share and dispose of intermediate, aligned memory buffers, pass events between themselves, and exist within a framework that enables modular development The common structure is paralleled where appropriate in a mathematical modelling environment and described via graph description language (GDL). FIG. 6 schematically depicts this common block and structure approach used in the CVM.

A similar analysis may be provided for 2-way systems, except that there is an additional CCS (calculus of concurrent systems) requirement and resource allocation issue, and the required ‘critical mass’ of processing engines is slightly different.

It is interesting that current generation third party application development tools and hardware deployment platforms (DSPs and DSP cores) do not reflect the structural realities discussed above, and do not (on the whole) provide hardware acceleration tailored towards communications baseband applications nor the 2 phase scheduling approach (see below). Nor do current embedded operating systems support these operations in any systematic or coherent manner.

However, the number of digital communications systems is increasing rapidly, creating a demand for rapid time-to-market deployment of baseband stacks. As explained above, a core innovative approach of the present invention is to exploit the underlying commonality and requirements of such systems by providing a software-hosted common ‘virtual machine layer’ (exemplified by the CVM embodiment) reifying these capabilities and software structure. One key commercial application is as a design solution for hard real time, multi-vendor, multi-protocol environments such as SoC (as noted above).

CVM Development Methodologies

The development methodology used in the CVM builds upon (and departs from) a methodology using layered development and layered deployment. These concepts will be discussed initially: Layered development refers to a process of progressing from mathematical models, through C++ or SDL code to a target assembler implementation (if necessary). Throughout this process, each of the modules in question is maintained at each of the necessary levels (for example, a convolutional decoder would exist as a parallel mathematical model, C++ implementation, SIMD model and assembler implementations in various target languages).

Layered deployment refers to the use of libraries to isolate the code as far as possible from the underlying hardware and host operating system when a receiver stack is actually implemented. Hence as much as possible of the code (high complexity but low MIPs requirement) is kept as generic SDL or ANSI-compliant C++ which is then simply recompiled for the target platform. For example, a library is used to provide platform-dependent functions such as simple I/O, allocation of memory buffers etc. Another library is used to provide high-cycle routines (such as the FFT, Viterbi decoder, etc.) in an architecture specific manner, which may involve the use of highly crafted assembler routines or even callthroughs to specialised hardware acceleration engines.

Ability to ‘pare down’ the ROM image of the CVM at build time to ensure that the minimum ROM (hence, ultimately, chip area) is used. This uses a minimal implementation of the CVM.

State machine functionality management (including potential integration with SDL)

Support for data structures

Transforms between different representations (such as fixed and floating point).

The goal of the CVM is to enable the rapid deployment of particular applications onto particular targets, with the multiplicity of applications coming at the development stage. Conventional OSs are designed for run-time support of a variety of apps that are essentially unknown when the OS is loaded, but this is typically not the case with the CVM. Moreover, the CVM does not need to handle interaction with a user, except by supporting presentation streams through portals provided by the ‘host’ OS.

The CVM incorporates a number of the features that are currently in the high-level C++ code of a DAB stack into the infrastructure level (such as the appropriate modular structure for the development of symbol-directed and data-directed processing), and is not simply a ‘library wrapper’.

The CVM concept rests upon the idea (critically dependent upon domain knowledge that can only be achieved through review of the various standards and the process of actually building the stacks) that abstracting the common functions and (importantly) processing structures required by modern digital broadcast and communications standards is possible and can be achieved elegantly through an appropriate software abstraction layer coupled with a systematic layered development environment.

CVM Advantages

With the CVM, stack developers are isolated from the particular hardware in use. The CVM provides support for the structures (e.g., symbol and data-directed pipelines, and state machines), functions (e.g., memory allocation and real time resource and concurrency management) and libraries (e.g., for FFT, Viterbi, convolution, etc.) required by digital communication baseband stacks to enable code to be written once, in a high-level language (SDL, ANSI C/C++ or Java) and merely recompiled (if necessary, with Java it would not be, and COM or some other form of component intercommunication technology can provide the ‘binary level’ glue to link the modules together) to run on a particular platform, making calls through to the hardware abstraction layer provided by the CVM layer.

Prototyping using the CVM will be very rapid, with each of the DSP modules paralleled by a mathematical model. Memory allocation and partitioning will be supported by an automated toolset (parameterised by the desired target hardware) rather than relying on guesswork. Once the processing chain is established on the model (which will optionally be performed by graphical arrangement and parameterisation rather than coding) and is working successfully, it will be possible to run a real-time PC-based version (using the Intel MMX/SIMD version of the CVM, together with RadioScape's generic baseband processor module). Any changes to the standard code (e.g. a custom equaliser) may then be integrated in a modular, incremental fashion and the code-test-edit cycle (being PC based) could use all the latest PC development tools, and be very rapid. Use of hardware acceleration on the target platform will be covered by the CVM (since all of the required cycle-intensive features for digital communications baseband processing will be provided as library calls at the CVM API). Clearly, the use of an appropriately adapted underlying hardware unit, would provide targeted acceleration for most of the desired functions. For many applications, the support of lightweight pre-emptive multithreading and other low-level functions on the CVM itself will obviate the need to use any other RTOS, but interaction with a user-OS (such as Windows CE or Symbian's EPOC) will be supported and straightforward through the APIs discussed above.

With this approach, a CVM-compatible stack, once written, would be portable instantly to any of the hardware platforms onto which the CVM itself had been ported, (always providing, of course, that there were sufficient resources (MIPs, memory, bandwidth) on the target machine to execute the desired stack in real time) without involving extra work. This would represent a substantial market opportunity (assuming reasonable cross-platform penetration of the CVM) for stack vendors, as it will essentially insulate their developments from hardware specificity. There is also a particularly significant commercial opportunity for designing multi-vendor SoC products (see above).

From the hardware vendor's point of view, the advantage of the CVM is that once it is ported for a given processor, that processor would automatically support (resources permitting) all stacks that had been written to the CVM API. This, of course, obviates the need for the hardware provider to get into the applications business; they need only port the CVM. It also means that the need to produce and support a full-specification development environment and toolset is reduced, since stack vendors (for the digital communications market at least) would then be able to develop code purely in ANSI C/C++ or Java. It should be noted that the CVM concept does not apply to all digital signal processing tasks, for example, making a PID controller for use in a car braking system. The reason that the CVM concept works for digital communication baseband processing is that, as explained above, there is a large pool of commonality in such systems that can be exploited; however, the CVM does not provide all the tools, structures or functions that would be required for other digital signal processing tasks, necessarily. Of course, it would potentially be possible to identify other such ‘islands’ of common function and extend the CVM idiom to cover their needs, but we are focussed here on the baseband aspects because they are highly in demand, and strongly exhibit the necessary commonality. The CVM approach leaves the hardware vendor free to compete not on the existing application set, but rather on the virtues of their hardware (e.g., MIPs, targeted acceleration, memory, power consumption).

The CVM Development Cycle

The process of actually using the CVM to develop a baseband stack will now be described. For the purposes of this specification, a device is the target being developed, such as a digital radio. A component is an identifiable specific part of it: either software, hardware, or both. ‘Interpreted’ means code (possibly compiled) which reads in configurations at run time.

The CVM Development Cycle begins with the ‘Component Definition Language’. This language enables the full externally visible attributes of a component to be specified, as well as its behaviour. The intention is that this can be written by a manufacturer or (as will be seen later) could be generated by test runs of an instrumented CVM.

Via a set of plug-ins the Component Definition Language can be read in to a mathematical modelling tool, such as the industry popular MatLab or Mathematica. Using the modelling tool, the theoretical behaviour of all components to be used in the device would be explored and understood.

The results of this investigation would then be either transcribed, or output via another plug in to be developed, into ‘Device Definition Language’. Just as Component Definition Language defines a component, this defines the target device being built, and will contain such elements as which components are used.

In effect, the Device Definition Language defines the communications ‘Pipeline’ that is being developed. The Pipeline concept is important since most communications devices can be thought of as the process of moving information through a pipeline, performing transforms on the way. It is in effect an electronic assembly line, but rather than operate on parts of a car, it operates on items of data commonly called ‘symbols’. Thus a radio signal would eventually be transformed to an audio signal. Of course, ‘real’ devices are often more complicated than a simple pipeline, and may have more than one pipeline, branches, or loops. The CVM development process allows a pipeline design to be tested before a full hardware version is ever built. This leads to shorter development times.

To fully define a target device, or pipeline, more information is needed. We also need a description of the resources (such as CPU rate) available on our target, and this is defined in a ‘Conformance Scripting Language’ and interconnects. We also need to know how each component is used (both physical and software APIs); this is achieved using ‘Component API Specifications’.

These three resources: the Device Definition Language, the Conformance Scripting Language, and the Component API Specifications, are now used within one of several possible CVMs: The first is the ‘Instrumented Interpreted’ (or, preferably, Instrumented and Compiled, which will perform more rapidly than an Instrumented Interpreted version) Pipeline Manager. This has some similarity to a software ICE. It reads the three resources and then emulates the pipeline (emulation may be in real time): so if the target is a radio it then runs as a radio. Because of the Conformance Scripting Language it is able to simulate any bottlenecks or resource limitations that would exist on the target device and is useful for development and de-bugging. In addition to running, the Instrumented Interpreted/ or Instrumented Compiled Pipeline Manager also outputs diagnostic information for each device—in Component Definition Language. This is important, since it can now be fed back into the development cycle and merged with the original Component Definition Language descriptions to refine that description. Hence, information on actual performance is made available to the designer before any hardware is constructed, and this is where the (substantial) development savings are made. This closes the inner loop of the development cycle. The Instrumented Interpreted or Instrumented Compiled Pipeline Manager incorporates run-time versions of the CVM core. It is possible for software elements of the Instrumented Interpreted or Instrumented Compiled Pipeline Manager to be replaced by hardware versions. (Ideally one at a time, so that bugs can be detected as they are introduced.) This is another development process enhancement This corresponds to the 2 Phase Scheduling process (see above) involving the design time portioning of engines across the computational substrate.

The second CVM is an ‘Interpreted Pipeline Manager’. It is not instrumented, but in other regards is identical. It may be used in development and debugging and by a manufacturer to produce a complete product. This is the third benefit: much of the work in writing a communications device is already done. It also incorporates run-time versions of the CVM core.

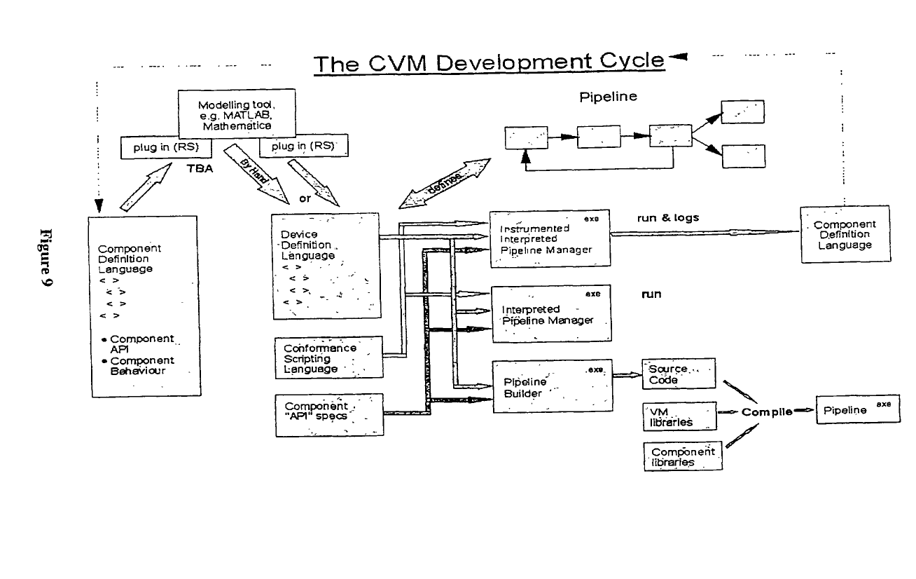

The third CVM is a ‘Pipeline Builder’. It can be thought of as a Compiled Non-Instrumented variant. Like the other two it reads the three resources, but instead of running it outputs computer source code, such as C, which can be compiled to produce a Pipeline implementation. For this reason it must have available to it CVM libraries. Testing this closes the outer loop of the development cycle. The overall approach of the CVM development cycle is shown schematically at FIGS. 8 and 9.

In the prior art section of this specification, we acknowledged the eXpressDSP Real-Time Software Technology from Texas Instruments Incorporated. The key advances possessed by the CVM will now be apparent to the skilled implementer. They include the following:

EXpressDSP is not a virtual machine layer as such.

CVM allows portability between various DSP platforms simply by porting the virtual machine; it is not tied to one platform (as the TI system is)

CVM includes integration with mathematical modelling

CVM allows the development of stacks using PC-based tools, not the less capable DSP-based tools

CVM includes the ability to ‘real time’ prototype on the PC, moving module-by-module onto the target environment

CVM includes the ability to generate resource timings by running a standard code set, and then generate an ‘architecture description’ profile from this

CVM allows development using high-level languages, since most of the ‘high cycle’ routines are already ‘in the environment’ of the CVM, which is oriented towards the signal processing requirements of baseband communication engines rather than a generic ‘real time software foundation’

CVM also includes the sort of data, dynamic resource, and buffer management commonly required for baseband DSP

CVM gives provision for a-priori resource prediction and concurrency analysis

CVM includes not merely functional elements (an API) but also the call structure (how the DSP code functions dynamically) as well as the full development paradigm support (from mathematical modelling, resource modelling, through PC-based prototyping and finally end-target deployment)

CVM allows the use of a third-party RTOS if desired, and can also operate without an RTOS if desired.

CVM offers 2 Phase scheduling

CVM enables advantages in migrating to ASICs and SoCs

CVM offers runtime and design tools which are fully integrated yet platform independent.

### Appendix 1

Examples of Core Processes

Signal Transforms and Frequency Domain Analysis

Signal Flow Graphs (SFG)

Discrete Frequency DFT

Windowing (Hamming, Hanning etc.)

Digital Filtering

Digital FIR Filters

Impulse Response

Frequency Response

FIR Low Pass Digital Filter

Infinite Impulse Response Digital Filters

Adaptive Signal Processing

Components for Adaptive Signal Processing including Adaptive Digital Filters

Channel Identification

Echo Cancellation

Acoustic Echo Cancellation

Background Noise Suppression

Channel Equalisation

Adaptive Line Enhancement (ALE)

Adaptive Algorithms, including:

Minimising the Mean Squared Error

Adaptive Algorithm for FIR Filter

Mean Squared Error

Minimum Mean Squared Error Solution

Wiener-Hopf Solution

Gradient Techniques 1

Gradient Techniques 2

The LMS Algorithm

Recursive Least Squares

Adaptive IIR Filtering

Gradient IIR Filtering Techniques

Feintuch's IIR LMS

Equation Frror LMS Algonthm

Directed Mode (DDM)

Subband Adaptive Filter (SAF) Structure

Multirate Signal Processing

Upsampling & Downsampling

Interpolating Low Pass Filter

Oversampling and Reconstrunction

Sigma-Delta Processing Architecture

Subband Processing

M-Channel Filter Banks by Iteration

Modulated Filter Banks

Polyphase Filter Banks

QMF Filter Banks

Audio Signal Source Coding

Lossless Huffman Coding/Decoding

Linear PCM

Companding

Adaptive Quantization Tools

Linear Predictive Coding

Long-Term Prediction

Delta Modulation (DM)

Differential PCM (DPCM)

Adaptive DPCM (ADPCM)

LPC Vocoder

Code-Excited Linear Prediction (CELP)

Algebraic CELP (ACELP)

Subband Coding

Tools for Psychoacoustics

Spectral Masking

Temporal Masking

Precision Adaptive Subband Coding and bit Allocation and bit Stream Formatting tools

Digital Modulation

XOR long an short code spreading/despreading

Amplitude Modulation

Quadrature Amplitude Modulation (QAM)

Quadrature Demodulation

Complex Quadrature Modulation

Complex Quadrature Demodulation

QPSK

n-PSK

M-ary Amplitude Shift Keying

π/n QPSK

Unipolar RZ and NRZ Signalling

Polar and Bipolar RZ and NRZ Signalling

Bandpass Shift Keying, including

Amplitude (On-Off) Shift Keying

Binary Phase Shift Keying (BPSK)

Frequency Shift Keying including

Bandpass Filtering for BPSK

Pulse Shaping including

Nyquist (Sinc) Pulse Shaping

Raised Cosine Pulse Shaping

Root Raised Cosine Pulse Shaping

Spread Spectrum Tools

Pseudo Random Code Generation

Gold Sequences

Kasami Sequences

Orthogonal Spreading Codes

Variable Length OC Generation

Orthogonal Walsh codes

Code Detection

Rake Receiver implementing

NBI Rejection Techniques including

Prediction filters

NBI rejection in Transform Domain

Decision feedback NBI rejection

Tools for Management of Multiple Access & Detection

TDMA including

TDMA Frames

TDMA combined with FDMA

CDMA including

Direct Sequence (DS) CDMA

Power Control

Beamforming Tools

Frequency Hopping CDMA

Multiuser Detection (MUD)

Multiple Access Interference Suppression

Decorrelator

Interference canceller

Adaptive MMSE

MMSE receiver training

Adaptive MMSE receiver DDM

Mobile Channels

Rayleigh Fading Suppression mechanisms (Gaussian, Riceian)

Modelling and suppression tools, including:

Time spreading

Time spreading: coherence bandwidth

Time spreading: flat fading

Time spreading: Freq selective fading

Time variant behaviour of the channel

Doppler effect

Channel Coding

Cyclic Coder

Reed Solomon Encoder

Convolutional Encoder

CE Puncturing

Interleaving

Convolutional Decoder

Viterbi Decoder (Hard and soft decision)

Turbo Codes

Turbo EnCoding

Turbo DeCoding

Equalisation

Adaptive Channel Equalisation

FIR Equaliser

Decision Feedback Equaliser

Direct conversion toolkit

QAM Analog RF/IF Architecture

QAM IF Downconversion support

Bandpass Sigma Delta support

Bandpass Sigma Delta to Baseband support

Bandpass and fs/4 Systems

Signal Processing Library Functions

This section describes some of the signal processing functions available with the CVM

Vector Manipulation Functions

AutoCorrelate Estimates a normal, biased or unbiased auto-correlation of an input vector and stores the result in a second vector

Conjugate (vector) Computes the complex conjugate of a vector, the result can be returned in place or in a second vector.

Conjugate (value) Returns the conjugate of a complex value.

ExtendedConjugate Computes the conjugate-sytnmetric extension of a vector in-place or in a new vector.

Exp Computes a vector where each element is e to the power of the corresponding element in the input vector. The result can be returned in place or in a second vector.

InverseThreshold Computes the inverse of the elements of a vector, with a threshold value. The result can be returned in place or in a second vector.

Threshold Performs the threshold operation on a vector. The result can be returned in place or in a second vector.

CrossCorrelate Estimates the cross-correlation of two vectors and stores the result in a third vector.

DotProduct Computes a dot product of two vectors after applying the ExtendedConjucate operation to them.

ExtendedDotProd Computes a dot product of two conjugate-symmetric extended vectors.

DownSample Down-samples a signal, conceptually decreasing its sampling rate by an integer factor. Returns the result in a second vector.

Max, Returns the maximum value in a vector.

Mean Computes the mean (average) of the elements in a vector.

Min Returns the minimum value in a vector.

UpSample Up-samples a signal, conceptually increasing its sampling rate by an integer factor. Returns the result in a second vector.

PowerSpectrum (1) Returns the power spectrum of a complex vector in a second vector.

PowerSpectrum (2) Computes the power spectrum of a complex vector whose real and imaginary components are two vectors. Stores the results in a third vector.

Add Adds two vectors and stores the result in a third.

Subtract Subtracts one vector from another and stores the result in a third.

Multiply Multiplies two vectors and stores the result in a third.

Divide Divides one vector by another and stores the result in a third.

Complex Vector Operations

ImaginaryPart Returns the imaginary part of a complex vector in a second vector.

RealPart Returns the real part of a complex vector in a second vector.

Magnitude (1) Computes the magnitudes of elements of a complex vector and stores the result in a second vector.

Magnitude (2) This second version calculates the magnitudes of elements of the complex vector whose real and imaginary components are specified in individual real vectors and stores the result in a third vector.

Phase (1) Returns the phase angles of elements of a complex vector in a second vector.

Phase (2) Computes the phase angles of elements of the complex input vector whose real and imaginary components are specified in real and imaginary vectors, respectively. The function stores the resulting phase angles in a third vector.

ComplexToPolar Converts the complex real/imaginary (Cartesian coordinate X/Y) pairs of individual input vectors to polar coordinate form. One version stores the magnitude (radius) component of each element in one vector and the phase (angle) component of each element in another vector.

ComplexToPolar A second version returns the polar co-ordinates as (magnitude, phase) pairs in a single vector

PolarToComplex Converts the polar form (magnitude, phase) pairs stored in a vector into a complex vector. Returned in a second vector.

PolarToComplex Converts the polar form magnitude/phase pairs stored in the individual vectors into a complex vector. The function stores the real component of the result in a third vector and the imaginary component in a fourth vector.

PolarToComplex Converts the polar form magnitude/phase pairs stored in two individual vectors into a complex vector. The function stores the real component of the result in a third vector and the imaginary component in a fourth vector.

Sample Quantisation

These methods convert between linear and nonlinear quantisation schemes. The number of bits used and the non linear parameters used can be varied.

ALawToLinear Converts a vector of A-law encoded samples to linear samples. The result can be returned in place or in a second vector.

LinearToALaw Encodes a vector of linear samples using the A-law format The result can be returned in place or in a second vector.

LinearToMuLaw Encodes the linear samples in a vector using the μ-law. The result can be returned in place or in a second vector.

MuLawToLinear Converts a vector of 8-bit μ-law encoded samples to the linear format. The result can be returned in place or in a second vector.

Sample-Generating Functions

RandomGaussian Computes a vector of pseudo-random samples with a Gaussian distribution.

InitialiseTone Initialises a sinusoid generator with a given frequency, phase and magnitude.

NextTone Produces the next sample of a sinusoid of frequency, phase and magnitude specified using InitialiseTone.

InitialiseTriangle Initialises a triangle wave generator with a given frequency, phase and magnitude.

NextTriangle Produces the next sample of a triangle wave generated using the parameters in InitialiseTriangle.

Windowing Functions

BartlettWindow Multiplies a vector by a Bartlett windowing function. The result is returned in a second vector.

BlackmanWindow Multiplies a vector by a Blackman windowing function with a user-specified parameter. The result is returned in a second vector.

HammingWindow Multiplies a vector by a Hamming windowing function. The result is returned in a second vector.

HannWindow Multiplies a vector by a Hann windowing function. The result is returned in a second vector.

KaiserWndow Multiplies a vector by a Kaiser windowing function. The result is returned in a second vector.

Convolution Functions

Convolve Performs finite, linear convolution of two sequences.

Convolve2D Performs finite, linear convolution of two two-dimensional signals.

Filter2D Filters a two-dimensional signal similar to Convolve2D, but with the input and output arrays of the same size.

Fourier Transform Functions

Versions of these methods exist for a number of different data storage (fixed, floating and integer) formats.

DiscreteFT Computes a discrete Fourier transform in-place or in a second vector.

InitialiseGoertz Initialises the data used by Goertzel functions.

ResetGoertz Resets the internal delay line used by the Goertzel functions.

GoertzFT (1) Computes the DFT for a given frequency for a single signal count.

GoertzFT (2) Computes the DFT for a given frequency for a block of successive signal counts.

FFT (1) Computes a complex Fast Fourier Transform of a vector, either inplace or in a new vector.

FFT (2) Computes a forward Fast Fourier Transform of two conjugate-symmetric signals, either in-place or in a new vector.

FFT (3) Computes a forward Fast Fourier Transform of a conjugate-symmetric signal, either in-place or in a new vector.

FFT (4) Computes a Fast Fourier Transform of a complex vector and returns the result in two separate (real and imaginary) vectors.

FFT (5) Computes a Fast Fourier Transform of a complex vector provided as two separate (real and imaginary) vectors returns the result in two separate (real and imaginary) vectors.

IFFT (1) Computes an inverse Fast Fourier Transform of a vector, either in-place or in a new vector.

IFFT (2) Computes an inverse Fast Fourier Transform of two conjugate-symmetric signals, either in-place or in a new vector.

IFFT (3) Computes an inverse Fast Fourier Transform of a conjugate-symmetric signal, either in-place or in a new vector.

Finite Impulse Response Filter Functions

InitialiseFIR Initialises a low-level, single-rate finite impulse response filter with a set of delay line values and taps.

FIR Filters a single sample through a low-level, finite impulse response filter, previously configured using InitialiseFIR.

BlockFIR Filters a block of samples through a low-level, finite impulse response filter.

GetFIRDelays Gets the delay line values for a low-level, finite impulse response filter.

GetFIRTaps Gets the tap coefficients for a low-level, finite impulse response filter.

SetFIRDelays Changes the delay line values for a low-level, finite impulse response filter.

SetFIRTaps Changes the tap coefficients for a low-level, finite impulse response filter.

InitisliseMultiFIR Initialises a low-level, multi-rate finite impulse response filter.

MultiFIR Filters a single sample through a low-level, multi-rate finite impulse response filter, previously configured using InitisliseMultiFIR

BlockMultiFIR Filters a block of samples through a low-level, multi-rate finite impulse response filter, previously configured using InitisliseMultiFIR.

Least Mean Squares Adaptation Filter Functions

InitialiseSALF Initialise a low-level, single-rate, adaptive FIR filter that uses the least mean squares (LMS) algorithm.

InitialiseMALF Initialise a low-level, multi-rate, adaptive FIR filter that uses the least mean squares (LMS) algorithm.

InitALFDelay Initialises a delay line for a low-level, adaptive FIR filter that uses the least mean squares(LMS) algorithm.

SALF Filter a sample through a low-level, single-rate, adaptive FIR filter that uses the least mean squares (LMS) algorithm.

MALF Filter a sample through a low-level, multi-rate, adaptive FIR filter that uses the least mean squares (LMS) algorithm.

SLF Filter a sample through a low-level, single-rate, adaptive FIR filter that uses the least mean squares (LMS) algorithm, but without adapting the filter for a secondary signal.

MLF Filter a sample through a low-level, multi-rate, adaptive FIR filter that uses the least mean squares (LMS) algorithm, but without adapting the filter for a secondary signal.

EnginesALF Filter a block of samples through a low-level, single-rate, adaptive FIR filter that uses the least mean squares (LMS) algorithm.

BlockMALF Filter a block of samples through a low-level, multi-rate, adaptive FIR filter that uses the least mean squares (LMS) algorithm.

EnginesLF Filter a block of samples through a low-level, single-rate, adaptive FIR filter that uses the least mean squares (LMS) algorithm, but without adapting the filter for a secondary signal.

BlockMLF Filter a block of samples through a low-level, multi-rate, adaptive FIR filter that uses the least mean squares (LMS) algorithm, but without adapting the filter for a secondary signal.

SetALFDelays Sets the delay line values for a low-level, adaptive FIR filter that uses the least mean squares (LMS) algorithm.

SetALFLeaks Sets the leak values for a low-level, adaptive FIR filter that uses the least mean squares (LMS) algorithm.

SetALFSteps Sets the step values for a low-level, adaptive FIR filter that uses he least mean squares (LMS) algorithm.

SetALFTaps Sets the taps coefficients for a low-level, adaptive FIR filter that uses the least mean squares (LMS) algorithm.

GetALFDelays Gets the delay line values for a low-level, adaptive FIR filter that uses the least mean squares (LMS) algorithm.

GetALFLeaks Gets the leak values for a low-level, adaptive FIR filter that uses the least mean squares (LMS) algorithm.

GetALFSteps Gets the step values for a low-level, adaptive FIR filter that uses he least mean squares (LMS) algorithm.

GetALFTaps Gets the taps coefficients for a low-level, adaptive FIR filter that uses the least mean squares (LMS) algorithm.

Infinite Impulse Response Filter Functions

InitialiseIIR Initialises a low-level, infinite, impulse response filter of a specified order.

InitialiseBiquadIIR Initialises a low-level, infinite impulse response (IIR) filter to reference a cascade of biquads (second-order IIR sections).

InitialiseIIRDelay Initialises the delay line for a low-level, infinite impulse response (IIR) filter.

IIR Filters a single sample through a low-level, infinite impulse response filter.

BlockIIR Filters a block of samples through a low-level, infinite impulse response filter.

Wavelet Functions

DecomposeWavelet Decomposes signals into wavelet series.

ReconstructWavelet Reconstructs signals from wavelet decomposition.

Discrete Cosine Transform Function

DCT Performs the Discrete Cosine Transform (DCT).

Vector Data Conversion Functions

All the functions described in this section can operate on a number of different data formats (such as various integer lengths, different floating point formats and fixed point representations of floating point numbers). The Signal Processing Library will contain methods to translate single values and vectors between all pairs of formats supported.

1. A method of designing, modelling or fabricating a communications baseband stack, comprising the steps of:
(a) creating a description of one or more of the following parameters of the baseband stack:
(i) resource requirements;
(ii) capabilities;
(iii) behaviour; and
(b) using that description as an input to software comprising a virtual machine layer optimised for a communications DSP in order to generate an emulation of the baseband stack to be designed, modelled or fabricated.

2. The method of claim 1 comprising the steps of:
(a) using, for one or more components to be incorporated in the baseband stack, a component description which defines some or all of the externally visible attributes of a component, as well as its behaviour, as an input to a mathematical modelling tool programmed to output component related performance data for each component;
(b) processing the component related performance data for each component to yield a baseband stack description;
(c) creating a resources description defining the resources of the baseband stack;
(d) creating an interface description defining how each component is to be used in the baseband stack; and
(e) using each of the baseband stack description, the resources description, and the interface description as the inputs to the software.

3. The method of claim 2 in which the software emulates the baseband stack and is both instrumented and interpreted/compiled.

4. The method of claim 3, in which the software outputs diagnostic information in respect of a component in the same format as the component description for that component in order to refine the quality of the component description.

5. The method of claim 4 in which the diagnostic information in the component description is fed back as an input to the software to improve the accuracy of the modelling.

6. The method of claim 2 and any claim dependent on claim 2 where the software outputs computer source code which can be interpreted or compiled to fabricate an actual baseband stack implementation.

7. The method of any preceding claim in which components or modules of the baseband stack can be incrementally ported to a target DSP to enable testing and debugging of individual ported components or modules.

8. The method of any preceding claim in which:
(a) a first test is carried out using software to emulate a given hardware component as part of a design or modelling process;
(b) the emulated component is replaced with the hardware component, and
(c) a further test is carried out.

9. The method of claim 1 in which the virtual machine layer allows statistical modelling in which available resources and interconnect characteristics are represented as statistical distribution functions.

10. The method of claim 1 in which the virtual machine layer allows low MIPS code to interface with high MIPS processes by using APIs presented by the virtual machine layer.

11. The method of claim 10 in which the high MIPS processes are implementations of abstract processes and are organised in a runtime environment in such a way that access cost is optimised.

12. The method of claim 1 in which the virtual machine layer comprises a scheduler which is programmed to co-schedule processes between different engines in order to give optimal resource utilisation during either or both of (i) the design and modelling phase and (ii) a runtime, and in which the resource allocation involves one or both of the following steps: (a) measurement using a statistical function; (b) modelling using a statistical distribution function.

13. The method of claim 12 in which the virtual machine layer supports underlying high MIPs algorithms common to a number of different baseband processing algorithms, and makes these accessible to high level, architecture neutral, potentially high complexity but low-MIPs control flows through a scheduler interface, which allows the control flow to specify the algorithm to be executed, together with a set of resource constraint envelopes, relating to one or more of: time of execution, memory, interconnect bandwidth, inside of which the caller desires the execution to take place.

14. The method of claim 12 adapted to allow, during design or modelling, datapath partioning of high MIPS processes across different engines.

15. The method of claim 14 in which the scheduler is aware, during runtime, of the datapath partioning decisions made across different engines.

16. The method of claim 10 in which the low MIPS complex code is expressed at least in part in a language not designed for real time operations.

17. The method of claim 16 in which the language is SDL.

18. The method of claim 10 which enables the low MIPS complex code to be represented in an architecture neutral manner.

19. The method of claim 10 which enables a baseband stack to be constructed with architecture neutral, low MIPS control codes, in which the control codes use a set of architecture neutral APIs specified by the virtual machine layer in order to access architecture specific high MIPS processes.

20. The method of claim 19 in which at least one high MIPS engine provides a resource for several different kinds of baseband stack.

21. The method of claim 10 programmed to characterise the static and dynamic resource requirements of different processes so that they can be co-scheduled in real-time with other processes.

22. The method of claim 21 further comprising fully integrated mathematical models, statistical simulation tools and a priori partioning simulation tools.

23. The method of any preceding operating as a design or modelling platform for a system on a chip.

24. The method of claim 23, in which intellectual property blocks, each from several different vendors, can be combined in the system on a chip by virtue of the static and dynamic resource requirements of each block being modelled by the software so that multiple blocks can be co-scheduled together in real-time.

25. The method of claim 24 in which the blocks perform high MIPS operations.

26. The method of claim 24 in which the blocks perform low MIPS, control operations.

27. The method of claim 9 as used in a process of migrating the substrate on which digital signal processing is performed from (a) a PC prototype for non-real time design and modelling to (b) one or more DSP chips with one or more external FPGAs for runtime.

28. The method of claim 27 in which the substrate is subsequently migrated to a custom ASIC.

29. The method of claim 10 in which the virtual machine layer is programmed with or enables access to one or more of the following:
(a) core processes;
(b) core structures;
(c) core functions:
(d) flow control;
(e) state management.

30. The method of claim 29 in which the core processes include algorithms to perform one or more of the following: source coding, channel coding, modulation, or their inverses, namely source decoding, channel decoding and demodulation.

31. The method of claim 29 in which the core structures comprise a symbol processing section (concerned with processing full symbols, regardless of whether all the information held within that symbol is to be used) and a data directed processing section, in which only those bits which hold relevant information are processed.

32. The method of claim 31 in which the core structure is comprised of processing modules operable to allocate, share and dispose of intermediate, aligned memory buffers, and pass events between themselves.

33. The method of claim 29 in which the core functions include one or more of the following: resource allocation and scheduling, including memory allocation, real time resource allocation and concurrency management.

34. The method of claim 29 operable to access PC debug tools.

35. The method of claim 29 which is operable with a component, in which only that information necessary to enable the software to operate with and/or otherwise model the performance of the component is supplied by the owner of the intellectual property in the component.

36. The method of claim 29 which is operable with a standardised description of the characteristics (including interface and non-interface behaviour) of communications components to enable a simulator, emulator or modelling tool to accurately estimate the resource requirements of a system using those components.

37. The method of claim 29 operable to model time, CPU, memory, interconnect scheduling and concurrency restraints, enabling mapping onto a real time OS, non real-time OS, virtual machine or hardware.

38. A baseband stack developed using the method of any preceding claim.

39. A communications device using the baseband stack of claim 38.

40. A system on a chip developed using the method of any preceding claim 1-37.

41. A method of defining a component using a standardised description of the characteristics (including interface and/or non-interface behaviour) of that component whereby that standardised description can be used in a method of claim 1 or constitute the component description of claim 2 and any preceding claim dependent on claim 2.

42. A method of defining a baseband stack using a language designed to define some or all of the functionality of the stack to estimate, simulate or fabricate a real stack using the method of any preceding claim 1-37.
